(19) United States
(12) Patent Application Publication
(10) Pub. No.: US 2014/0125520 A1
(43) Pub. Date: May 8, 2014

(54) ANTI-JAMMING SUBSYSTEM EMPLOYING AN ANTENNA WITH A HORIZONTAL RECEPTION PATTERN

(71) Applicant: Patrick C. Fenton, Calgary (CA)

(72) Inventor: Patrick C. Fenton, Calgary (CA)

(21) Appl. No.: 13/530,302

(22) Filed: Jun. 22, 2012

(51) Int. Cl. G01S 19/21

(52) U.S. Cl. CPC G01S 19/215
USPC 342/357.59

(57) ABSTRACT

An anti-jamming subsystem for a jamming signal originating along the horizon includes an anti-jamming antenna with a horizontal reception pattern constrained to receive signals originating along the horizon. The subsystem receives the signals from the anti-jamming antenna and a reference antenna, which has a half hemispherical reception pattern looking skyward. The subsystem utilizes associated phase information to phase shift the signals received by the anti jamming antenna and produce an anti-jamming signal, and combines the anti jamming signal with the signals received by the reference antenna to produce signals in which the interference from the jamming signal originating along the horizon is actively cancelled and the phase and timing information of signals received by the reference antenna from at least higher elevation satellites is preserved. The horizontal reception pattern of the anti-jamming antenna may be circular or directional toward a known jammer positioned along the horizon.

### CROSS-REFERENCE TO RELATED APPLICATIONS

The present application is related to the following commonly assigned U.S. patent application Ser. No. 13/489,801, which was filed on Jun. 6, 2012, by Patrick C. Fenton for a ANTI-JAMMING SUBSYSTEM EMPLOYING AN ANTENNA ARRAY WITH A HORIZONTAL CIRCULAR RECEPTION PATTERN and is hereby incorporated by reference.

### BACKGROUND OF THE INVENTION

1. Field of the Invention

The invention relates generally to anti-jamming systems for use with satellite system antennas and, in particular, to anti-jamming systems that are associated with jamming signals that originate along the horizon.

2. Background Information

Global navigation satellite systems (GNSS) provide ranging signals that are utilized in applications that determine global positions for surveys, global positions of delivery trucks, global positions of cellular phones for use by social media and also for emergency 911 purposes, and so forth. As is well known, GNSS antennas receive signals from a plurality of GNSS satellites and associated GNSS receivers determine positions based on the timing of codes and carriers in the received GNSS satellite signals. Increasingly, portable jammers are employed to disrupt particular position calculation operations.

The jammers emit signals at the frequencies of the GNSS satellite signals. The jammer signals that are received by the GNSS antenna interfere with the GNSS satellite signals received by the GNSS antenna and effectively prevent a GNSS receiver from determining an accurate position based on the received GNSS satellite signals. A local jammer may be used, for example, on a delivery truck, to provide jamming signals to the GNSS antenna located on the truck, and thus, prevent the associated GNSS receiver from calculating accurate positions, when the driver wishes to drive the truck on an unauthorized route or at an unauthorized time.

Unfortunately, the signals emitted by a local jammer not only interfere with the GNSS signals received by the co-located GNSS antenna, in the example, the GNSS antenna on the truck, the jammer signals also interfere with the GNSS satellite signals received by nearby GNSS antennas, that is, GNSS antennas that are located within one or two miles of the jammer. Accordingly, as the truck travels along its unauthorized route, the on-board jammer may inadvertently disrupt the operations of various GNSS receivers that are being used, for example, for surveying, and thus disrupt the survey work by prohibiting the calculation of positions of survey points using the GNSS signals received at various times that correspond to the presence of a portable jammer in the area.

The portable jammer emits jamming signals that have the same frequencies as the GNSS satellite signals and have, at the nearby GNSS antennas, higher power than the GNSS satellite signals which are received after travelling much longer distances through the atmosphere. Thus, the jamming signals overwhelm the GNSS satellite signals at the nearby GNSS antennas, and the GNSS receivers cannot then determine the code and carrier timing needed for position calculations.

The jamming emissions from the jammers of interest can be considered as originating along the horizon. The azimuth angles of the jammer emissions at the nearby GNSS antennas are thus similar to the azimuth angles of signals arriving from low-elevation GNSS satellites that are rising above the horizon and into the sky view of the GNSS antennas. The signals from the low-elevation GNSS satellites may be required for the position calculations, and thus, it is desirable to receive the GNSS satellite signals from the low-elevation GNSS satellites. However, it is not desirable at any given time to suffer the adverse effects of interference associated with jamming emissions originating from a jammer along the horizon.

What is needed is an anti-jamming mechanism that addresses the adverse effects of the jamming emissions originating along the horizon in the received signals, while at the same time preserving for use in position calculations the received GNSS satellite signals from the higher elevation GNSS satellites as well as certain or all of the low elevation satellites.

### SUMMARY OF THE INVENTION

An anti-jamming subsystem that is directed to jamming signals originating along the horizon includes an anti-jamming antenna that effectively has a horizontal circular or directional reception pattern that is constrained to receive signals originating along the horizon. The subsystem electronics receives signals from the anti-jamming antenna and also signals from a reference antenna, which has a half hemispherical reception pattern that is positioned to have an upward looking view of the sky, for example, a reference GNSS antenna. The subsystem utilizes associated phase information to rotate, or phase shift, and scale the signals received by the anti-jamming antenna, to produce an anti-jamming signal that has an opposite phase and the same magnitude as the jamming signal received by the reference GNSS antenna that originating along the horizon. The subsystem then combines the anti-jamming signal with the signals received by the reference antenna, to produce signals for further processing in which the interference from the jamming signal originating along the horizon is actively cancelled and the signal characteristics of the signals received by the reference antenna from at least higher elevation satellites are not adversely affected. The signals for further processing thus correspond to a combined antenna reception pattern from which the signals from the jammer along the horizon are cancelled, and the phase and timing information of signals originating from higher elevation transmitters is preserved.

### BRIEF DESCRIPTION OF THE DRAWINGS

The invention description below refers to the accompanying drawings, of which:

FIG. 1 is a schematic diagram of a system that utilizes an anti-jamming subsystem constructed in accordance with the invention;

FIG. 2 illustrates electronics of the anti-jamming subsystem of FIG. 1 in more detail; and

FIG. 3 is a flow chart of the operations of the anti-jamming subsystem of FIG. 1.

### DETAILED DESCRIPTION OF AN ILLUSTRATIVE EMBODIMENT

The anti-jamming subsystem is described as operating with a conventional GNSS antenna as the reference antenna. However, the invention may be used with reference antennas utilized in other satellite systems and/or systems utilizing relatively high elevation signal transmitters.

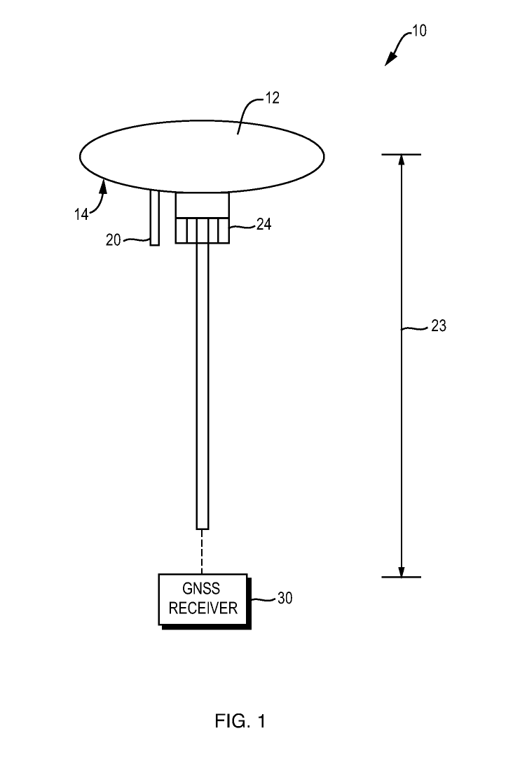

Referring now to FIG. 1, an anti-jamming subsystem 10 connects electrically in an RF signal path 23 from a GNSS antenna 12, referred to herein as “the reference antenna 12,” which, as is conventional, has a half hemispherical radiation pattern and is positioned to have an upward looking view of the sky. As shown, the subsystem 10 includes an anti-jamming antenna 20 and electronics 24 that receives signals from the reference antenna 12 and the anti-jamming antenna 20. The subsystem provides signals for further processing to a GNSS receiver 30.

The anti-jamming antenna 20 effectively has a horizontal circular reception pattern constrained to receiving signals originating along the horizon. As shown, the subsystem 10, or at least the anti-jamming antenna 20, is placed below and in close proximity to the reference GNSS antenna 12. Accordingly, signals in a vertical direction are prevented from reaching the antenna 20 by a ground plane 14 of the reference antenna 12. In the example, the antenna 20 is a dipole antenna and the reference antenna 12 is a geodetic antenna. For ease of explanation, the anti-jamming antenna will be referred to hereinafter as “the dipole antenna.” However, the antenna 20 may be, for example, a dipole, helical or patch antenna.

As discussed in more detail below, electronics 24 in the anti-jamming subsystem 10 rotates, or phase shifts, and scales the signals received by the dipole antenna 20 to produce an anti-jamming signal that has the opposite phase and the same magnitude as the jamming signal that originated along the horizon and is received by the reference antenna 12. The electronics 24 further combines the anti-jamming signal with the signals received by the reference antenna 12, to produce signals for further processing in which the interference from the jammer signal that originates along the horizon is significantly reduced, i.e., actively minimized or cancelled. In the event that the dipole antenna receives more than one jamming signal originating along the horizon at a given time, the anti-jamming subsystem operates to actively minimize or cancel the strongest of these jamming signals.

More specifically, the electronics 24 rotates, or phase shifts, the signals from the dipole antenna to produce a signal that is the inverse of the jamming signal originating along the horizon. When the anti-jamming signal is, in turn, combined or mixed with the signals received by the reference antenna 12, the jamming signal is actively cancelled from a combined antenna reception pattern, while the signals received by the reference antenna from at least the higher elevation GNSS satellites are otherwise unaffected by the anti-jamming signal. Further, the signals from one or more lower elevation satellites that have phases that differ sufficiently from the phase of the jamming signal originating along the horizon may also be available to the receiver for further processing once the jamming signal is actively cancelled. Accordingly, when the resulting signals for further processing are provided to the GNSS receiver 30, the receiver processes the signals in a conventional manner to determine satellite signal phase and timing information.

The dipole antenna 20 may be placed directly underneath the ground plane 14 of the reference antenna 12 such that the ground plane 14 prevents signals arriving vertically from reaching the antenna 20. Alternatively, the antenna 20 may have a metal top or a housing (not shown) that provides a ground plane that is strategically positioned to block the vertical signals, and the antenna may then be placed in close proximity to the reference antenna.

The subsystem 10 thus produces an anti-jamming signal that combines or mixes with the signals received by the reference antenna 12, to eliminate the interference from the jammer along the horizon while also preserving attributes of interest in the received GNSS satellite signals. Accordingly, the carrier-to-noise ratios, the phase center offsets and the phase center variations associated with at least the higher elevation GNSS satellite signals are not significantly affected in the resulting signals for further processing.

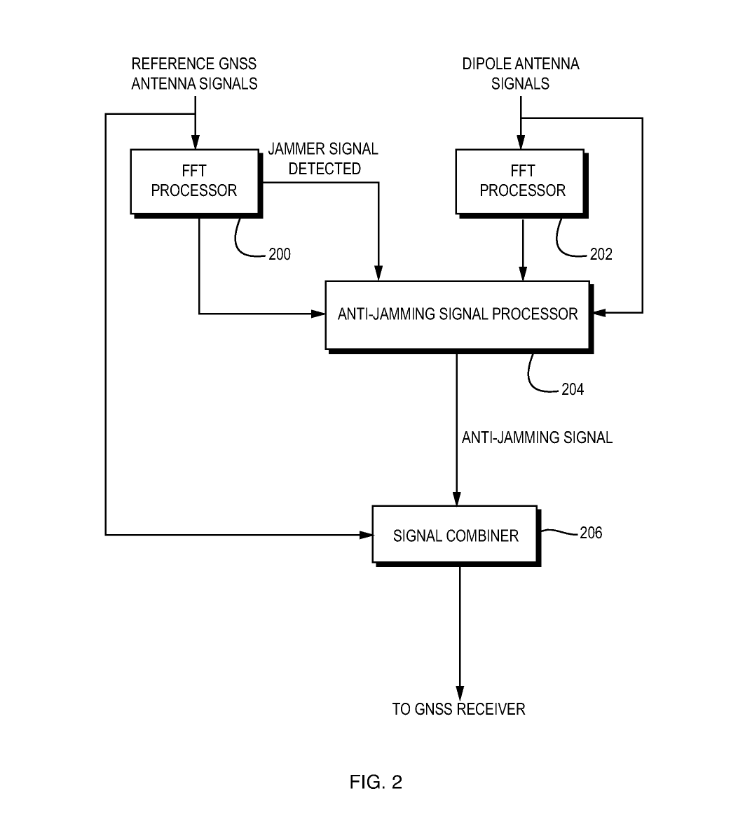

Referring now to FIG. 2, the signals received by the reference antenna 12 and the dipole antenna 20 are provided to the sub-system electronics 24, which includes FFT processors 200 and 202 that operate in a known manner to perform FFTs on the received signals. An anti-jamming signal processor 204, operating in a known manner, utilizes phase information from the processing of the signals from the reference antenna and the dipole antenna and computes the phase rotation that is necessary to produce the anti-jamming signal. The anti-jamming signal processor 204, also operating in a known manner, computes the scale factor to adjust the amplitude of the dipole antenna signal, to essentially match the power level of the jamming signal of interest in the signals received by the reference antenna 12. The phase rotation angle and scale factor are then used to rotate and scale the signal from the dipole antenna 20 to produce the anti-jamming signal.

The anti-jamming signal processor 204 thus operates in a known manner to utilize the phase information from the FFTs and determine a phase rotation that rotates the jamming signal in the dipole antenna signals to produce an anti-jamming signal that has a phase that is the inverse of the phase of the same jamming signal in the reference antenna signals. The processor 204 further determines a scale factor S that results in the anti-jamming signal having the same power as the same jamming signal in the reference antenna signals. The processor applies the phase rotation and scale factor as A=S·Cosθ and B=S·Sinθ to I and Q samples of the dipole antenna signal to produce I and Q components of the anti-jamming signal as Iₐⱼ=I_{d}×A +Q_{d}×B and Qₐⱼ=Q_{d}×A−I_{d}×B, where the subscripts “d” and “aj” refer to dipole antenna signals and anti-jamming signals, respectively.

A signal combiner, or mixer, 206 combines the anti-jamming signal with the signals received by the reference antenna 12, to produce the signal for further processing that is then provided to the receiver 30. When the anti-jamming signal and the signals received by the reference antenna 12 are combined, the interference from the jammer emissions is effectively removed, i.e., substantially reduced or cancelled, and the signals from at least the higher elevation GNSS satellites are not otherwise affected.

The anti-jamming signal processor 204 may perform a least squares analysis in a known manner, to determine the appropriate phase shift and scale values to apply to the signal received by the dipole antenna 20 to produce the anti-jamming signal. The processor thus uses techniques employed by known side lobe cancellers to effectively isolate and amplify the jamming signal. However, the known side lobe cancellers operate with respective antennas that have essentially the same reception patterns, such that the respective antennas “see” the same signals. Using the subsystem 10, the antenna 20 is configured specifically to have a reception pattern that is essentially separated from the reception pattern of the reference antenna 12, that is, that overlaps only along the horizon.

With the separation in the reception patterns, the processor 204 produces an anti-jamming signal that actively eliminates or minimizes the interference from the jammer signal originating along the horizon when the anti-jamming signal is combined with the signals received by the reference antenna. At the same time, the combined signals also preserve the signal characteristics, i.e., phase and timing content, of at least the signals received by the reference antenna 12 from higher elevation angles that are outside of the constrained horizontal circular reception pattern of the antenna 20.

In an alternative embodiment of the anti-jamming subsystem, the electronics 24 performs additional processing to first determine if a jamming signal is present in the signals received by the reference antenna 12. If so, the electronics then determines if same jamming signal is received also by the dipole antenna 20. The subsystem next produces the anti-jamming signal and combines the anti-jamming signal with the signals received by the reference antenna only if the jamming signal is detected in the signals received by both the reference antenna 12 and the dipole antenna 20. In this way, the subsystem does not needlessly add noise into the satellite signals received by the reference antenna when the jamming signal originating along the horizon is absent.

The FFT processor 200 determines that a jamming signal is present if one or more frequency components of the signals received by the reference antenna have power above a predetermined threshold. When the FFT processor 200 detects at least one jamming signal in the signals received by the reference antenna 12, the FFT processor 202 determines if the antenna 20 is also receiving a same jamming signal. The FFT processor 202 thus determines if the antenna 20 has received a signal with the same frequency components as a detected jamming signal. If so, the FFT processor 202 directs the signal processor 204 to produce the anti-jamming signal and/or the signal combiner 206 to mix the anti-jamming signal with the signals received by the reference antenna 12.

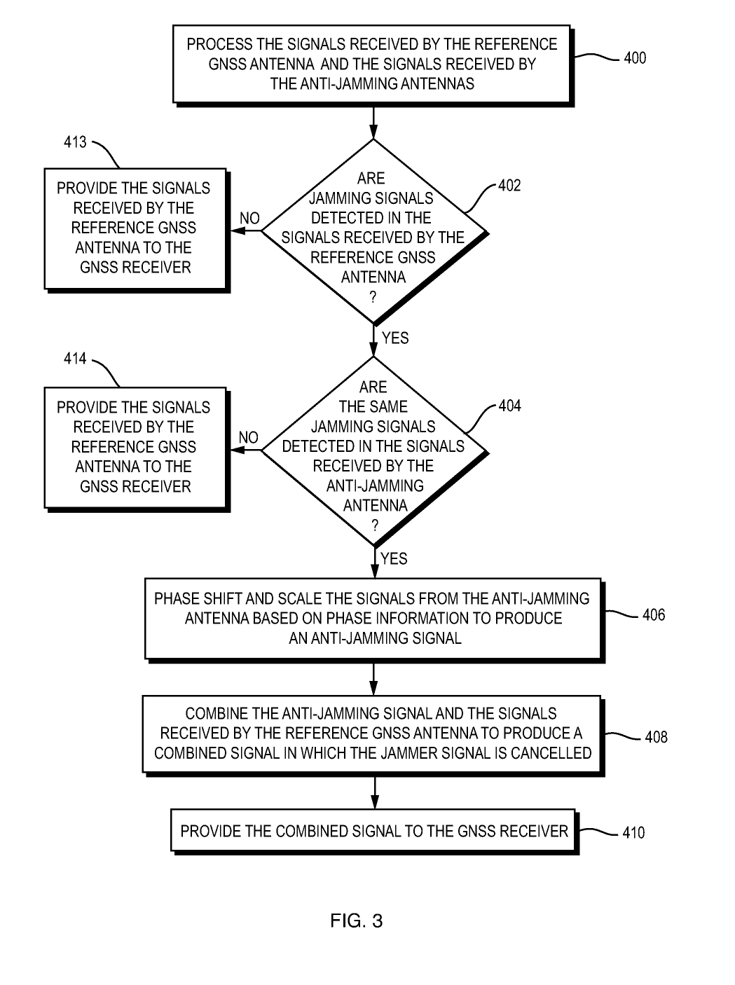

Referring now to FIG. 3, the operations of the electronics 24 to detect jamming signals and remove the interference associated with the jamming signal originating along the horizon will be described in more detail. Signals received from the GNSS reference antenna 12 are processed to determine if there are higher power frequency components (Step 400). In the example, the signals are applied to the FFT processor 200, which performs a conventional FFT and detects spikes in the frequency bins to determine the presence of at least one jamming signal (Step 402).

If at least one jamming signal is detected, that is, in the example, if the spikes are detected in at least one frequency bin, the subsystem determines if the jamming signal is present also in the signals received by the dipole antenna 20 (Step 404). Thus, the FFT processor 202 determines whether or not the antenna 20 has also received the jamming signal by checking for spikes in one or more of the corresponding frequency bins.

If a signal having essentially the same one or more frequency components as the jamming signal is detected in the signals received by the antenna 20, the signal processor 204 utilizes the associated phase information to produce an anti-jamming signal that has the opposite phase and the same magnitude, or power level, as the jamming signal originating along the horizon that is detected within the reference antenna's signal (Step 406). The anti-jamming signal processor 204 thus appropriately rotates and scales the signals received by the antenna 20 to form the anti-jamming signal. As discussed, the anti-jamming signal processor 204 may perform a least squares analysis to determine the appropriate rotation and scaling using known side lobe cancellation techniques.

In step 408, a combining circuit 206 combines, or mixes, the anti-jamming signal and the signals received by the reference antenna 12 and produces the signals for further processing in which the interference from the jammer signal originating along the horizon is effectively eliminated and the signal characteristics of signals received from at least the higher elevation GNSS satellites are preserved. In step 410, the resulting signals for further processing are provided to the GNSS receiver 30, which operates in a known manner to determine satellite signal phase and timing information.

If no jamming signal is detected in the signals received by the reference antenna 12, the subsystem 10 provides the signals received by the referenced GNSS antenna to the GNSS receiver 30 without combining them with signals produced by the anti-jamming signal processor 204 (Step 412). Similarly, if a jamming signal is detected in the signals received by the reference antenna 12, but the same signal is not detected in the signals received by the respective antennas 20, as would be the case if the jamming signal originated from a high elevation angle, the signals received by the referenced GNSS antenna are provided to the GNSS receiver 30 without combining them with the anti-jamming signal produced by the anti-jamming signal processor (Step 414).

The GNSS receiver 30, which receives either the resulting signals for further processing or the signals received by the reference antenna, operates in a known manner to determine satellite signal phase and timing information. If jammer emissions from jammers that are located at elevations above the horizon and/or weaker signals from other jammers along the horizon are included in the signals provided to the GNSS receiver 30, the receiver may attempt compensation for the associated interference using known signal processing techniques.

Referring again to FIGS. 1, the anti-jamming subsystem 10 operates to effectively eliminate from the signals to be processed by the receiver 30 the interference of a jamming signal that originates along the horizon. The anti-jamming subsystem is designed to operate with existing reference antennas 12, by fitting under the existing antenna and/or in close proximity to the reference antenna. Notably, no changes are required to be made to the reference GNSS antenna 12. Alternatively, the anti-jamming subsystem could be integrated into the GNSS antenna.

The reference antenna 12 may be, for example, a patch antenna, a pinwheel antenna, or other geodetic antenna. One example is a pole mountable survey antenna, such as NovAtel Model 703GGG. The antenna 20 may be any style of antenna with a horizontal circular radiation pattern or, alternatively, with a horizontal reception pattern directed in the known direction of expected jamming signals. As discussed, the antenna 20 may be, for example, a dipole, helical or patch antenna. The antenna 20 may be positioned between top and bottom horizontal ground planes to limit its radiation pattern to the horizon. The bottom horizontal ground plane may be a ground plane of the antenna 20, and the top horizontal ground plane may be the ground plane 14 of the reference antenna 12 or an additional ground plane associated with the antenna 20.

The subsystem thus operates with an anti-jamming antenna that has a horizontal circular or directional reception pattern that is constrained to receiving only signals originating along the horizon. An antenna with a circular reception pattern is used when the directions of the jamming signals originating along the horizon are unknown. A directional antenna pointed toward the source of the jamming signal may be used if the direction of an expected jamming signal originating along the horizon can be determined. As an example, the subsystem may use a directional antenna, such as a horn or a dish focused in one direction, when source of the jamming signal is fixed electrical telecommunication equipment that is unintentionally emitting interfering frequencies. The subsystem 10 may be mounted such that the dipole antenna 20 is less than one wavelength from the phase center of the reference antenna 12. Alternatively, the subsystem may be constructed with and compensate for larger offsets.

While the interference associated with the jammer emissions from a jammer along the horizon is essentially eliminated as described above, GNSS signals reflected off of the ground and received by the dipole antenna 20 may be added into the GNSS signals received by the reference antenna 12 when the received signals and the anti-jamming signal are combined. Accordingly, some additional GNSS multipath interference may have to be handled by the GNSS receiver 30. Assuming the subsystem operates to first detect the presence of the jammer signal originating along the horizon, however, the reflected signals are added only at the times that the jammer emissions are detected.

While various processors are discussed, the operations may be performed by a single processor, by fewer processors or by more processors. The processors that are described as performing FFTs may instead perform other known processes for determining the presence of the one or more jamming signals in the signals received by the GNSS reference antenna and the signals received by the anti-jamming antenna. The processors that are described as performing a least squares analysis may instead perform other known processes to determine the appropriate rotation, or phase shift, and scaling to apply to the signals received by the anti-jamming antenna. The processors may, for example, utilize known reference signal techniques and other signal cancellation techniques.

What is claimed is:

1. An anti-jamming subsystem comprising:
a. an anti-jamming antenna configured to have a horizontal circular reception pattern and receive signals originating along the horizon and to be positioned in close proximity to a reference antenna having a half hemispherical reception pattern and positioned to have an upward looking view of the sky;
b. one or more processors that are configured to process signals received by the reference antenna and the signals received by the anti-jamming antenna and phase shift and scale the signals received by the anti-jamming antenna to produce an anti-jamming signal that combines with the signals received by the reference antenna to substantially cancel interference from a jamming signal originating along the horizon and preserve phase and timing information in signals originating from higher elevation transmitters.

2. The anti-jamming subsystem of claim 1 wherein the anti-jamming antenna is associated with a ground plane that prevents signals arriving vertically from reaching the array of antennas.

3. The anti-jamming subsystem of claim 1 wherein the anti-jamming antenna is positioned relative to a ground plane of the reference antenna such that the ground plane prevents signals arriving vertically from reaching the antennas.

4. The anti-jamming subsystem of claim 1 wherein the one or more processors perform Fast Fourier Transforms (FFTs) of the signals received by the reference antenna and the anti-jamming antenna and use phase information and power information to determine the phase shift and scaling to apply to the signals received by the anti-jamming s antenna to produce the anti-jamming signal.

5. The anti-jamming subsystem of claim 1 wherein the one or more processors
combine the anti-jamming signal with the signals received by the reference antenna to produce signals for further processing in which the jamming signal originating along the horizon is effectively cancelled and phase and timing information from signals received from transmitters above the horizon are preserved, and
provide the signals for further processing to a receiver.

6. The anti-jamming subsystem of claim 5 wherein the one or more processors determine if at least one jamming signal is present and received by both antennas before producing the combined signals for further processing.

7. The anti-jamming subsystem of claim 1 wherein the anti-jamming antenna is a dipole antenna, helical antenna or patch antenna.

8. The anti-jamming subsystem of claim 1 wherein the anti-jamming antenna is positioned between top and bottom horizontal ground planes.

9. The anti-jamming subsystem of claim 8 wherein one or both of the ground planes are provided within the subsystem.

10. The anti-jamming subsystem of claim 8 wherein the top ground plane is a ground plane of the reference antenna.

11. A method of producing signals with reduced interference from jamming signals originating along the horizon comprising:
a. receiving satellite signals using a reference antenna that has a half hemispherical reception pattern and is positioned to have an upward looking view of the sky;
b. receiving one or more jamming signals originating along the horizon using an anti-jamming antenna configured to have a horizontal circular reception pattern and constrained to receive signals originating along the horizon;
c. processing the signals received by the reference antenna and the anti-jamming antenna to produce an anti-jamming signal that has opposite phase and the same magnitude as the strongest jamming signal originating along the horizon; and
d. combining the anti-jamming signal with the signals received by the reference antenna to produce combined signals in which interference from the strongest jamming signal originating along the horizon is effectively eliminated and phase and timing information of signals originating from higher elevation satellites are preserved.

12. The method of claim 11 wherein the processing of the signals includes performing FFTs of the signals from the reference antenna and the anti-jamming antenna and a least squares analysis to determine phase shift and scaling to apply to the signals received by the anti-jamming antenna to produce the anti-jamming signal.

13. The method of claim 11 wherein the processing of the signals includes determining if the same jamming signal is present in the signals received by the reference antenna and by the anti-jamming antenna.

14. The method of claim 13 wherein the processing of the signals includes performing FFTs and determining if there are spikes in one or more corresponding frequency bins.

15. The method of claim 12 wherein the processing of the signals received by the anti-jamming antenna includes using phase information and power information from the FFT processing to determine the phase shift and scaling of the signals received by the anti-jamming antenna.

16. The method of claim 12 further including
determining if a same jamming signal is included in the signals received by the reference antenna and the anti-jamming antenna;
if not, using the signals received by the reference antenna to determine satellite signal phase and timing information; and
if so, using the combined signal to determine the satellite signal phase and timing information.

17. A system for removing interference from jamming signals:
a reference antenna with a half hemispherical reception pattern and positioned with an upward looking view of the sky;
an anti-jamming antenna with a horizontal reception pattern that is constrained to receive signals originating along the horizon;
one or more processors configured for processing the signals received by the reference antenna and the anti-jamming antenna and phase shifting and scaling the signals received by the anti-jamming antenna to produce an anti-jamming signal having an opposite phase and the same magnitude as a jamming signal originating along the horizon and received by the reference antenna; and
one or more processors configured for combining the anti-jamming signal with the signals received by the reference antenna to produce combined signals in which interference from the jamming signal originating along the horizon is actively cancelled and the phase and timing information for signals received from higher elevation transmitters are preserved.

18. The system of claim 17 further including one or more processors configured for detecting if the same jamming signal is received by both the reference antenna and the anti-jamming antenna.

19. The system of claim 17 wherein the horizontal reception pattern of the anti-jamming antenna is circular.

20. The system of claim 17 wherein the horizontal reception pattern of the anti-jamming antenna is directed in the direction of a known or estimated position of a source of the jamming signal originating along the horizon.
